(19) United States
(12) Patent Application Publication
(10) Pub. No.: US 2019/0005890 A1
(43) Pub. Date: Jan. 3, 2019

(54) DISPLAY APPARATUS AND CONTROL METHOD THEREOF

(71) Applicant: SAMSUNG ELECTRONICS CO., LTD., Suwon-si (KR)

(72) Inventor: Dae Sung LIM, Suwon-si (KR)

(73) Assignee: SAMSUNG ELECTRONICS CO., LTD., Suwon-si (KR)

(21) Appl. No.: 15/973,146

(22) Filed: May 7, 2018

(30) Foreign Application Priority Data
Jun. 30, 2017 (KR) 10-2017-0083571

(51) Int. Cl. G09G 3/34; G09G 3/36

(52) U.S. Cl. CPC G09G 3/342; G09G 3/3611; H04N 5/57; G09G 2320/064; G09G 2320/0252; G09G 2320/106

(57) ABSTRACT

There is provided a display apparatus including a display panel configured to display a plurality of frame images, a backlight unit including a plurality of light sources provided on at least one side of the display panel, the plurality of lights being arranged in a scanning direction of the display panel and a controller configured to divide an area of the display panel into a plurality of sub areas in a direction perpendicular to a direction in which the plurality of light sources are arranged and synchronize a dimming signal applied to at least one light source, among the plurality of light sources, a position of a subpixel area having a largest size of a motion among the plurality of sub areas.

### CROSS-REFERENCE TO RELATED APPLICATION

This application is based on and claims priority under 35 U.S.C. § 119 to Korean Patent Application No. 10-2017-0083571, filed on Jun. 30, 2017 in the Korean Intellectual Property Office, the disclosure of which is incorporated by reference herein in its entirety.

### BACKGROUND

### 1. Field

Embodiments of the present disclosure relate to a display apparatus in which a liquid crystal display panel is employed, and a control method thereof.

### 2. Description of the Related Art

Display panels may be divided into light emitting type display panels which emit light by themselves and non-light emitting type display panels which require a separate light source. A liquid crystal display (LCD) panel may be used as a representative non-light emitting type display panel.

A display apparatus including an LCD panel includes a backlight unit for supplying light from behind the LCD panel. Light supplied from the backlight unit passes through liquid crystals provided in the LCD panel and an amount of the light is adjusted, and passes through a color filter and a color is exhibited.

The LCD panel has a slower response speed than a related art cathode ray tube (CRT) display panel because the LCD panel has to change an arrangement of the liquid crystals in order to switch a screen. The slow response speed of the liquid crystals can cause a motion blur phenomenon when a rapid motion appears on the screen.

### SUMMARY

According to an aspect of the present disclosure, there is provided a display apparatus in which when an edge type display panel in which light sources of a backlight unit are arranged on at least one side of a display panel in a scanning direction is employed, an optimal motion blur improvement effect may be obtained by synchronizing a dimming point of the light source with an area having a largest motion size, and a control method thereof.

Additional aspects of the disclosure will be set forth in part in the description which follows and, in part, will be obvious from the description, or may be learned by practice of the disclosure.

According to an aspect of the present disclosure, there is provided a display apparatus comprising: a display panel configured to display a plurality of frame images; a backlight unit comprising a plurality of light sources provided on at least one side of the display panel, the plurality of lights being arranged in a scanning direction of the display panel; and a controller configured to divide an area of the display panel into a plurality of sub areas in a first direction perpendicular to a second direction in which the plurality of light sources are arranged and synchronize a dimming signal applied to at least one light source, among the plurality of light sources, at a position of a sub area having a largest size of a motion among the plurality of sub areas.

The controller maybe further configured to generate a dimming control signal for synchronizing an application time point of the dimming signal with a scanning time point of the sub area having the largest size of the motion.

The controller maybe further configured to the dimming control signal by providing an offset between the scanning time point of the sub area having the largest size of the motion and the application time point of the dimming signal.

The controller maybe further configured to compare the largest size of the motion to a preset reference value, and synchronize the dimming signal with the position of the sub area having the largest size of the motion when the largest size of the motion is greater than or equal to the reference value.

The controller maybe further configured to calculate the size of the motion for each of the sub areas using two or more frame images temporally adjacent to each other among the plurality of frame images.

The controller maybe further configured to calculate the size of the motion using a current frame image and a previous frame image among the plurality of frame images.

The controller maybe further configured to divide a screen displayed through the display panel into M areas in a direction perpendicular to the scanning direction and divide the screen into N areas in the scanning direction, and calculate the size of the motion for each of M×N areas, wherein M and N are integers of 2 or more.

The controller maybe further configured to divide the plurality of light sources into a plurality of blocks and controls the plurality of blocks in units of blocks.

A number of the blocks may proportional to a number of the N areas divided in the scanning direction in order to calculate the size of the motion.

The controller maybe further configured to determine a position of a sub area having a largest size of a motion for each block, and synchronize a dimming signal applied to a light source included in the block with the position of the sub area having the largest size of the motion.

When a sub area including a subtitle is present among the plurality of sub areas, the controller maybe further configured to synchronize the dimming signal with the sub area including the subtitle.

When the largest size of the motion is less than the reference value, the controller maybe further configured to generate a dimming control signal for applying the dimming signal at an integer multiple of a frame frequency to the plurality of frame images.

The dimming signal may comprise a pulse width modulation (PWM) signal.

The backlight unit may comprise a plurality of light sources arranged to face each other at both sides of the display panel.

According to another aspect of the present disclosure, there is provided a control method of a display apparatus comprising a display panel configured to display a plurality of frame images, and a backlight unit comprising a plurality of light sources disposed on at least one side of the display panel and arranged in a scanning direction of the display panel, the method comprising: dividing a screen displayed through the display panel into N areas in the scanning direction; dividing each of the N areas into a plurality M sub areas in a direction perpendicular to the scanning direction; calculating a size of a motion for each of the M sub areas of each of the N areas; and synchronizing a dimming signal applied to at least one light source, among the plurality of light sources, with a position of a sub area having a largest size of a motion among the M sub areas in at least one of the N areas, wherein M and N are integers of 2 or more.

The synchronizing of the dimming signal may comprise synchronizing an application time point of the dimming signal with a scanning time point of the sub area having the largest size of the motion.

The synchronizing of the dimming signal may comprise providing an offset between the scanning time point of the sub area having the largest size of the motion and the application time point of the dimming signal.

The synchronizing of the dimming signal may comprise: comparing the largest size of the motion to a preset reference value; and synchronizing the dimming signal with the position of the sub area having the largest size of the motion when the largest size of the motion is greater than or equal to the reference value.

The calculating of the size of the motion may comprise calculating the size of the motion using two or more frame images temporally adjacent to each other among the plurality of frame images.

The calculating of the size of the motion may comprise calculating the size of the motion using a current frame image and a previous frame image among the plurality of frame images.

According to another aspect of the present disclosure, there is provided a controller comprising: a processor configured to: divide a screen displayed through a display panel into N areas in a first direction of the display panel; divide each of the N areas into a plurality M sub areas in a second direction perpendicular to the first direction; calculate a size of a motion for each of the M sub areas of each of the N areas; and synchronize a dimming signal applied to at least one light source, among a plurality of light sources, based on the calculated size of the motion for each of the M sub areas in at least one of the N areas.

The processor maybe further configured to synchronize the dimming signal applied to the at least one light source, among a plurality of light sources, based on a position of a sub area having a largest size of a motion among the M sub areas in the at least one of the N areas.

The processor maybe further configured to: compare the largest size of the motion to a preset reference value; and synchronize the dimming signal with the position of the sub area having the largest size of the motion when the largest size of the motion is greater than or equal to the reference value.

### BRIEF DESCRIPTION OF THE DRAWINGS

These and/or other aspects of the disclosure will become apparent and more readily appreciated from the following description of the embodiments, taken in conjunction with the accompanying drawings of which:

FIGS. 1 and 2 are views showing an exterior of a display apparatus according to an embodiment of the present disclosure.

FIG. 3 is a diagram showing a structure of a display panel and a backlight unit which are included in a display apparatus according to the embodiment.

FIG. 4 is a side sectional view showing a single pixel area Px of the display panel included in the display apparatus according to the embodiment.

FIGS. 5 to 7 are views showing structures of the backlight unit included in the display apparatus according to the embodiment.

FIG. 8 is a control block diagram of a display apparatus according to an embodiment.

FIGS. 9 and 10 are views showing examples of areas controlled by the display apparatus according to the embodiment.

FIG. 11 is a control block diagram showing a configuration of the display apparatus according to the embodiment.

FIGS. 12 and 13 are views showing sizes of motions, which are calculated for each block by the controller of the display apparatus according to the embodiment.

FIG. 14 is a diagram showing a position-based PWM signal applied for each block of a backlight unit in the case in which the size of the motion for each area is the same as the example of FIG. 12 according to an embodiment.

FIG. 15 is a diagram showing a time-based PWM signal supplied for each block of the backlight unit in the case in which the size of the motion for each area is the same as the example of FIG. 12 according to an embodiment.

FIGS. 16 and 17 are diagrams showing examples of a PWM signal applied to improve a flicker phenomenon according to an embodiment.

FIG. 18 is a flowchart of a control method of a display apparatus according to an embodiment.

FIG. 19 is another flowchart of a control method of a display apparatus according to an embodiment.

FIG. 20 is still another flowchart of a control method of a display apparatus according to an embodiment.

### DETAILED DESCRIPTION

Hereinafter, embodiments of the present disclosure will be described in detail with reference to the accompanying drawings.

Embodiments described in this specification and configurations shown in the drawings are only exemplary examples of the disclosed disclosure. It should be understood that the disclosure covers various modifications that can substitute for the embodiments herein and drawings at a time of filing of this application.

It should be understood that the terminology used herein is for the purpose of describing particular embodiments only and is not intended to limit the disclosure.

For example, as used herein, the singular forms “a,” “an,” and “the” are intended to include the plural forms as well, unless the context clearly indicates otherwise.

It should be further understood that the terms “comprise,” “comprising,” “include,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof.

Terms including ordinal numbers such as “first,” “second,” etc. are used only to distinguish one element from another. For example, a second element could be named a first element, and a first element could be named a second element, without departing from the scope of the present disclosure.

Moreover, terms described in the specification such as “part,” “unit,” “block,” “member,” “module,” and the like may refer to a unit that processes at least one function or operation. For example, the above terms may refer to at least one piece of hardware such as a field-programmable gate array (FPGA), an application specific integrated circuit (ASIC), and the like, at least one piece of software stored in a memory, or at least one process processed by a processor.

Hereinafter, embodiments of the present disclosure will be described in detail with reference to the accompanying drawings. Like reference numerals or designations in the accompanying drawings may refer to like parts or components performing substantially the same function.

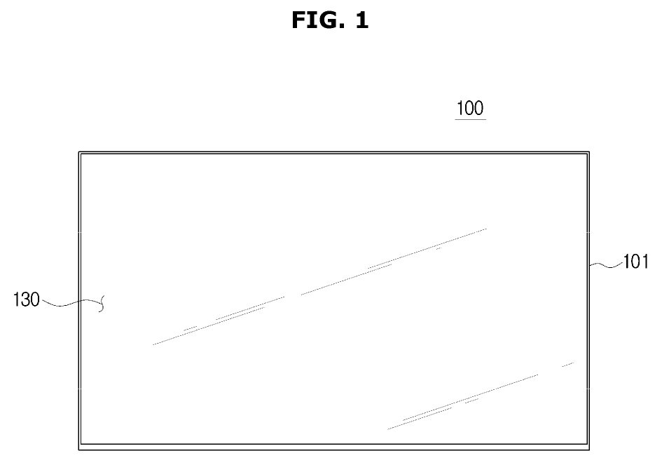

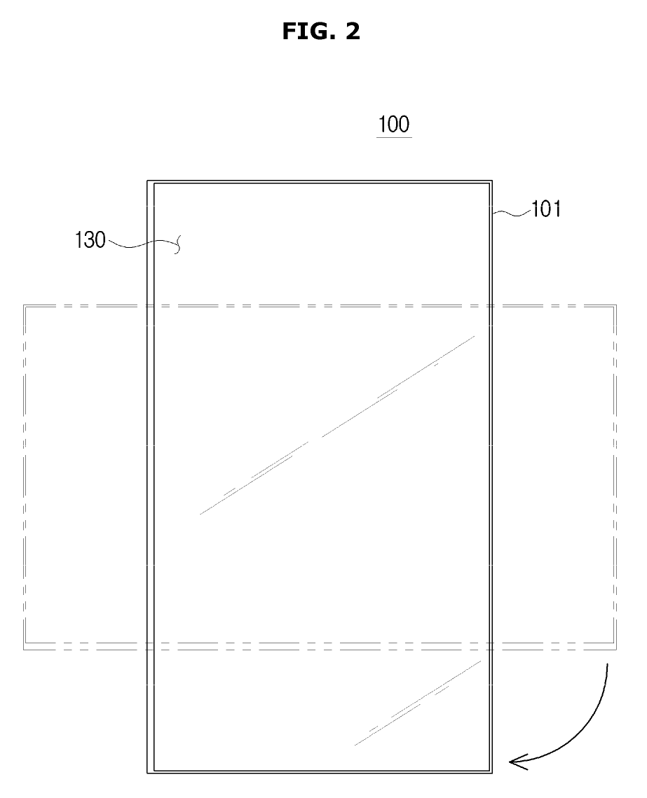

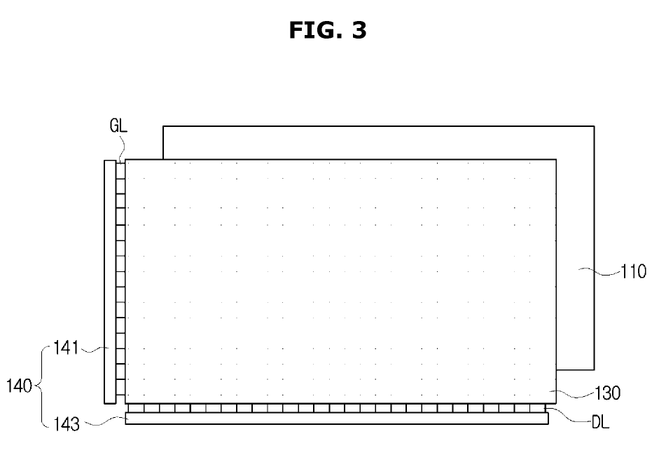

FIGS. 1 and 2 are views showing an exterior of a display apparatus according to an embodiment of the present disclosure, and FIG. 3 is a diagram showing a structure of a display panel and a backlight unit which are included in the display apparatus according to the embodiment.

A display apparatus 100 according to the embodiment refers to an apparatus capable of processing and outputting image signals which are stored in advance or received from the outside. For example, when the display apparatus 100 is a TV, the display apparatus 100 processes broadcast signals transmitted from a broadcasting station, content signals transmitted from a set-top box, or content signals transmitted from a playback device to output images and sounds synchronized with the images.

Hereinafter, in embodiments to be described below, the case in which the display apparatus 100 is a TV will be described as an example. However, the embodiment of the display apparatus 100 is not limited to the TV, and any display apparatus as long as it includes a display panel for displaying an image and a backlight unit for providing light to the display panel may become the embodiment of the display apparatus 100 without limitation of its name or type.

Referring to FIG. 1, the display apparatus 100 includes a main body 101, which forms an exterior of the display apparatus 100 and accommodates various components constituting the display apparatus 100, and a display panel 130, which is disposed on a front surface of the main body 101 and displays an image.

The display apparatus 100 may be implemented as a stand type display apparatus in which a support is provided below the main body 101 so that the main body 101 may be stably disposed on a horizontal plane, and may be implemented as a wall-mounted type display apparatus in which a support is connected to a rear surface of the main body 101 and the main body 101 is coupled to a wall through the support.

Further, the main body 101 may be rotatably provided around one position of the display panel 130. For example, when the main body 101 is rotated 90 degrees as shown in FIG. 2, the display panel 130 is vertically and horizontally reversed.

Referring to FIG. 3, a backlight unit 110 is disposed behind the display panel 130, and panel drivers 140 (gate driver 141 and data driver 143) are connected to the display panel 130 to provide an appropriate driving signal to the display panel 130, so that a desired image may be displayed.

The display panel 130 may be implemented as a non-light emitting display panel that does not emit light itself, and may be implemented, for example, as a liquid crystal display (LCD) panel. In one or more embodiments to be described below, the case in which the display panel 130 is implemented as an LCD panel will be described as an example.

The display panel 130 may display image information such as characters, numbers, figures, and the like by adjusting the transmittance of light passing through a liquid crystal layer, and the transmittance of the light passing through the liquid crystal layer may be adjusted according to an intensity of an applied voltage.

The display panel 130 may include a color filter layer, a thin film transistor (TFT) array panel, a liquid crystal layer, and a sealant.

The color filter layer may include red, green, and blue color filters formed in areas corresponding to pixel electrodes of the TFT array panel so that a color may be displayed for each pixel. Further, a common electrode made of a transparent conductive material such as indium tin oxide (ITO), indium zinc oxide (IZO), or the like may be formed on the color filter layer.

The TFT array panel of the display panel 130 may be spaced apart from the color filter layer and may include a plurality of gate lines GL, data lines DL, and pixel electrodes.

Here, the gate lines GL are arranged in a row direction to transmit gate signals, and the data lines DL are arranged in a column direction to transmit data signals. In this embodiment, the row direction refers to a direction parallel to a scanning direction or a direction in which light sources of the backlight unit 110 are arranged.

The pixel electrode may be connected to the gate line GL and the data line DL, and may include a switching element and a capacitor.

Here, the switching element is formed at an intersection of the gate line GL and the data line DL, and the capacitor may be connected to an output terminal of the switching element. The other terminal of the capacitor may be connected to a common voltage or may be connected to the gate line GL.

The liquid crystal layer included in the display panel 130 may be disposed between the color filter layer and the TFT array panel, and may include a sealant and liquid crystals contained in the sealant. An arrangement direction of the liquid crystal layer is changed by a voltage applied from the outside. In this case, the transmittance of light passing through the liquid crystal layer is adjusted.

The color filter layer, the TFT array panel, and the liquid crystal layer of the display panel 130 constitute a liquid crystal capacitor, and the liquid crystal capacitor constituted in this manner is connected to the output terminal of the switching element of the pixel electrode and the common voltage or a reference voltage.

The sealant is formed on edges of the color filter layer and the TFT array panel of the display panel 130, and combines the color filter layer and the TFT array panel. The sealant may allow a shape of the display panel 130 to be maintained.

The panel driver 140 may provide gate driving signals and data driving signals based on gate control signals and data control signals to each of the gate lines GL and the data lines DL formed on the TFT array panel to implement a desired image on the display panel 130.

The panel driver 140 may include a gate driver 141, which generates a gate pulse and supplies the gate pulse to the gate line GL, and a data driver 143, which generates a data voltage and supplies the data voltage to the data line DL.

The data driver 143 selects a gradation voltage for each data line based on image data and transmits the selected gradation voltage to the liquid crystals through the data line.

The gate driver 141 transmits an on or off signal based on the image data to a TFT, which is a switching element, in a scan line (or the gate line) to turn on or off the TFT. In this embodiment, a progressive scanning method may be used for performing scanning.

A data electrode of the TFT is connected to the data line DL, a gate electrode of the TFT is connected to the gate line GL, and a drain electrode of the TFT is connected to an ITO pixel electrode. Such a TFT is turned on when a scan signal is supplied to the scan line, and supplies a data signal supplied from the data line to the pixel electrode.

A predetermined voltage is applied to the common electrode, and, accordingly, an electric field is formed between the common electrode and the pixel electrode. An arrangement angle of the liquid crystals between the liquid crystal panels is changed by the electric field, and light transmittance is changed according to the changed arrangement angle and the desired image is displayed.

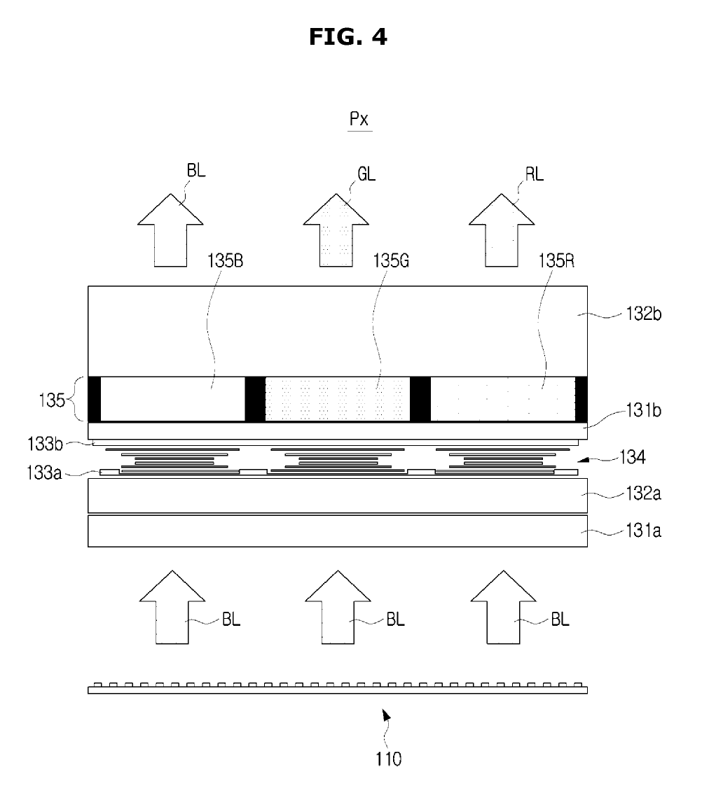

Hereinafter, a structure of a single pixel area of the display panel will be described with reference to FIG. 4.

FIG. 4 is a side sectional view showing a single pixel area Px of the display panel included in the display apparatus according to the embodiment.

In this embodiment, a direction in which light is emitted to the outside becomes a direction in which an image is provided to a viewer viewing the display panel 130, and becomes a front of the display panel 130.

Referring to FIG. 4, light emitted from the backlight unit 110 may be incident on the display panel 130, and thus the backlight unit 110 may emit, for example, blue light BL.

The blue light BL may be incident on a rear polarizing plate 131a of the display panel 130, and the rear polarizing plate 131a may polarize the blue light BL to transmit only light oscillating in the same direction as a polarization axis to a rear substrate 132a.

A rear electrode 133a may be provided on a front surface of the rear substrate 132a, and the rear electrode 133a may be a pixel electrode. The rear substrate 132a may be made of a transparent material such as poly(methyl methacrylate) (PMMA) or glass.

A front polarizing plate 131b may be disposed in front of the rear substrate 132a, and a front electrode 133b may be provided on a rear surface of the front polarizing plate 131b. The front electrode 133b may be a common electrode.

A gap between the rear substrate 132a and the front polarizing plate 131b may be filled with a liquid crystal layer 134. A current flows through the liquid crystal layer 134 according to a voltage applied to the rear electrode 133a and the front electrode 133b. When a current flows through the liquid crystal layer 134, an arrangement of liquid crystal molecules constituting the liquid crystal layer 134 is adjusted.

Light passing through the liquid crystal layer 134 is incident on the front polarizing plate 131b, and light passing through the front polarizing plate 131b is incident on a color filter layer 135 disposed on a front surface of the front polarizing plate 131b.

The color filter layer 135 includes a red light filter 135R for outputting red light RL, a green light filter 135G for outputting green light GL, and a blue light filter 135B for outputting blue light BL. In this case, a color filter composed of a dye or pigment which absorbs or transmits a wavelength of a specific region may be used in the color filter layer 135, and a quantum dot color filter which converts incident light into a specific color using quantum dots may be used in the color filter layer 135.

For example, the blue light filter 135B may transmit blue light and absorb colors other than the blue light, the green light filter 135G may transmit green light and absorb colors other than the green light, and the red light filter 135R may transmit red light and absorb colors other than the red light. In this case, white light may be incident from the backlight unit 110.

Alternatively, the red light filter 135R may convert incident light into red light using quantum dots, the green light filter 135G may convert incident light into green light using quantum dots, and the blue light filter 135B may transmit incident light. In this case, blue light may be incident from the backlight unit 110.

A unit consisting of the red light filter 135R, the green light filter 135G, and the blue light filter 135B may function as one pixel Px in the entire display panel 130, and such pixels may be arranged in two dimensions to make one image signal.

Light transmitted through the color filter layer 135 or color-converted by the color filter layer 135 is incident on a front substrate 132b, and light emitted to the outside through the front substrate 132b is displayed to the viewer as an image.

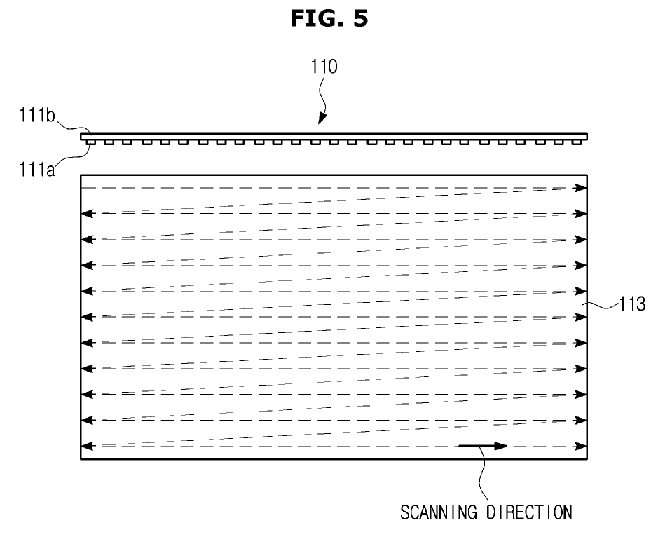

FIGS. 5 to 7 are views showing structures of the backlight unit included in the display apparatus according to the embodiment.

The backlight unit is provided behind the display panel, and supplies light required for the display panel to display an image. The backlight unit may be divided into an edge type backlight unit in which light sources are disposed at an edge of the display panel, and a direct type backlight unit in which light sources are arranged two-dimensionally below the display panel.

In the display apparatus 100 according to the embodiment, the backlight unit 110 may be implemented as an edge type backlight unit disposed on at least one side of the display panel 130.

As shown in FIGS. 5 to 7, the backlight unit 110 includes light sources 111a which generate light, and a light guide plate 113 which converts the light generated by the light sources 111a into sheet light.

The light sources 111a are provided on at least one side of the light guide plate 113 and outputs light toward the light guide plate 113. For example, the light source 111a may output blue light or white light. The light guide plate 113 may be made of PMMA, PC, or the like having high transparency and good strength.

The light source 111a may employ a light emitting diode (LED) lamp having a small heating value, and a plurality of lamps arranged in an array form may be electrically provided on a substrate 111b such as a printed circuit board (PCB).

The light guide plate 113 changes a traveling direction of light incident from a side face thereof and emits the light toward a front surface thereof. A plurality of convex stripes may be formed on a front surface of the light guide plate 113 to change the traveling direction of the light, and a plurality of dots may be formed on a rear surface of the light guide plate 113. Further, a size of the convex stripe, an interval between the convex stripes, a size of the dot, and an interval between the dots may be adjusted so that uniform light is emitted toward the front surface of the light guide plate 113.

Meanwhile, in the display apparatus 100 according to the embodiment, as shown in FIGS. 5 to 7, the light sources 111a are arranged in a scanning direction. That is, the light sources 111a may be arranged parallel to the gate line. In the embodiments of FIGS. 5 to 7, in order to explain a relationship between a scanning direction and an arrangement direction of the light sources 111a, the scanning direction is indicated on and along with the light guide plate 113.

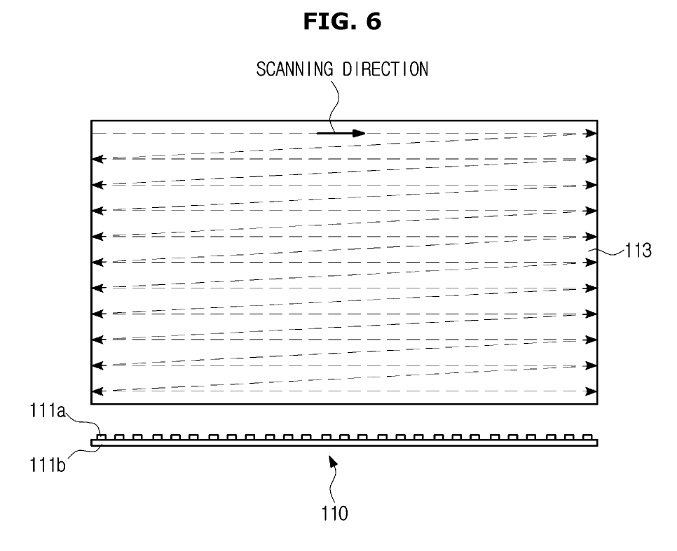

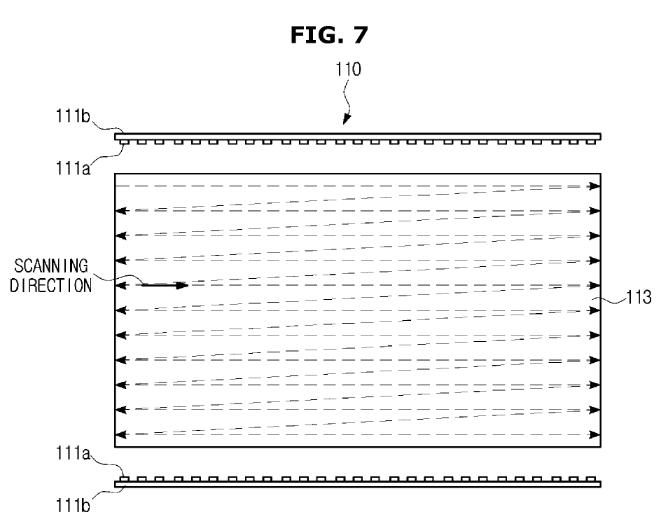

As shown in FIGS. 5 and 6, the light sources 111a may be arranged in the scanning direction or parallel to the gate line only at one side of the light guide plate 113 (i.e., top side in FIG. 5 and bottom side in FIG. 6), and, as shown in FIG. 7, the light sources 111a may be arranged at both sides of the light guide plate 113 to face each other.

As described above, the arrangement of the liquid crystal molecules constituting the liquid crystal layer 134 should be adjusted for each frame in order to display a desired image on the display apparatus 100. Therefore, when a size of a motion is large, a response speed of the liquid crystal layer 134 may not follow an amount of change of the pixel, and thus a motion blur phenomenon in which an afterimage of a previous frame is left may occur.

In the display apparatus 100 according to the embodiment, dimming control may be performed to improve the motion blur phenomenon. The entire screen may be divided into a plurality of areas and a dimming point of the backlight unit 110 may be controlled according to a size of a motion for each area, so that an optimal blur improving effect can be obtained. Hereinafter, a specific operation of the display apparatus 100 will be described.

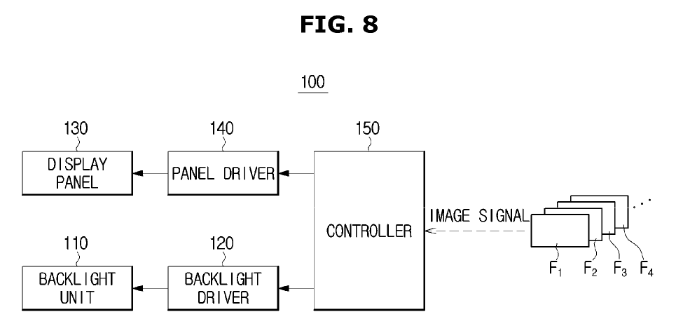

FIG. 8 is a control block diagram of a display apparatus according to an embodiment.

Referring to FIG. 8, a display apparatus 100 includes a display panel 130 which displays a desired image by adjusting an arrangement of liquid crystals, a panel driver 140 which drives the display panel 130, a backlight unit 110 which supplies light to the display panel 130, a backlight driver 120 which drives the backlight unit 110, and a controller 150 which generates various control signals for controlling the display panel 130 and the backlight unit 110 based on an input image signal.

Further, the controller 150 may divide an area to which light is supplied from at least one light source of a plurality of light sources 111a into a plurality of sub areas in a direction perpendicular to a direction in which the light sources 111a are arranged, and may generate a control signal for synchronizing a dimming signal applied to the at least one light source with a position of a sub area having a largest motion size among the plurality of sub areas.

Operations basically performed for displaying an image by the display panel 130, the panel driver 140, the backlight unit 110, and the backlight driver 120 are the same as those described above with reference to FIGS. 1 to 7.

The controller 150 receives image data including data of a plurality of frames F₁, F₂, F₃, F₄, . . . , and generates a gate control signal, a data control signal, a backlight control signal, and the like for displaying a frame image on the display panel 130 according to a predetermined frequency.

The controller 150 may control the light source 111a of the backlight unit 110 to be driven in an impulse mode. When the light source 111a of the backlight unit 110 is driven in the impulse mode, the light source 111a is not always turned on, but is turned on during a specific period and turned off during the remaining period so that the light source 111a is repeatedly turned on and off.

Further, the controller 150 may control the brightness of the light source 111a by a pulse width modulation (PWM) method. Therefore, the controller 150 may generate a backlight control signal for applying a PWM signal to the light source 111a of the backlight unit 110 according to a predetermined frequency and may transmit the backlight control signal to the backlight driver 120, and the backlight driver 120 may generate a PWM signal based on the transmitted control signal and apply the generated PWM signal to the light source 111a.

Meanwhile, the controller 150 may control the light source 111a of the backlight unit 110 in units of blocks. At least one light source 111a may be included in one block.

The controller 150 may divide the entire screen into a plurality of areas in a direction perpendicular to a direction in which the light sources 111a of the backlight unit 110 are arranged, and control a dimming point of each block based on a size of a motion for each area. Here, the dimming point refers to a time point at which a PWM signal is applied to the light source 111a.

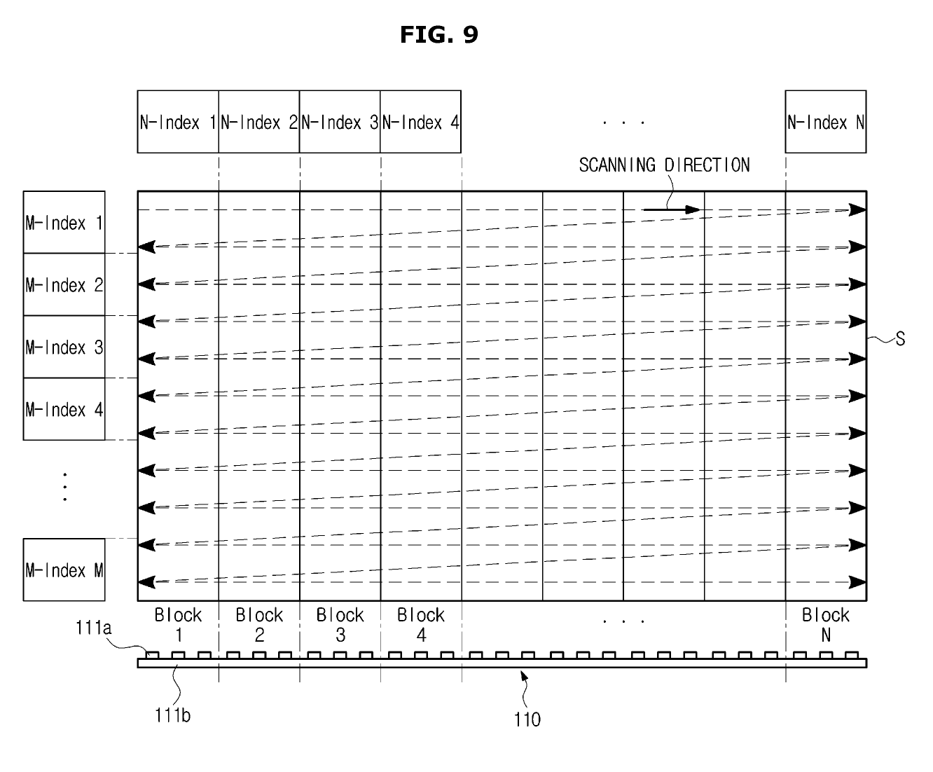

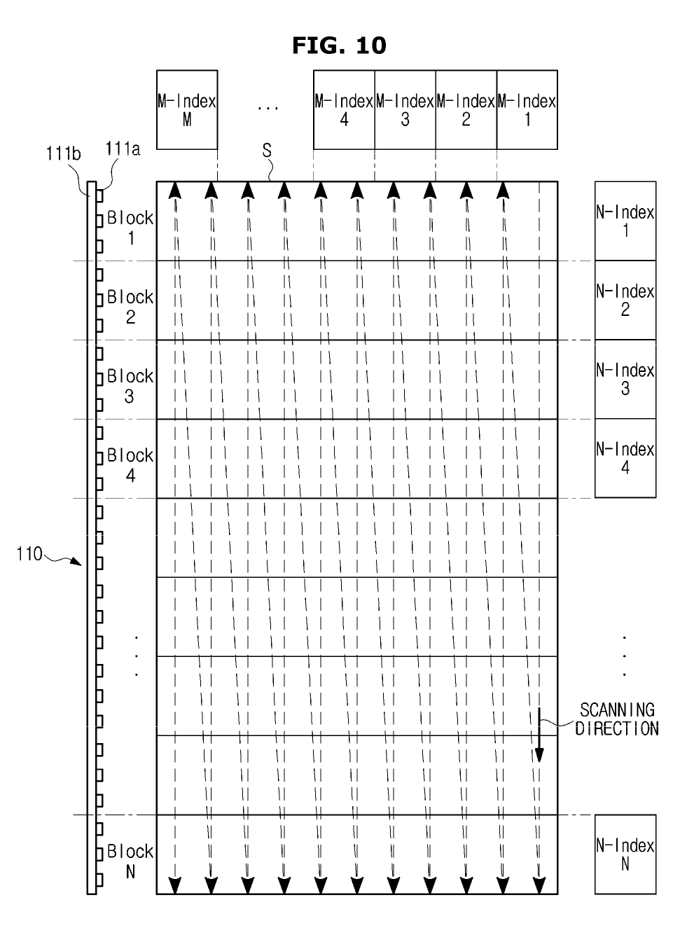

FIGS. 9 and 10 are views showing examples of areas controlled by the display apparatus according to the embodiment.

When the display apparatus 100 in a state of FIG. 9 is rotated clockwise by 90 degrees, a state of FIG. 10 is obtained.

As shown in FIGS. 9 and 10, the controller 150 may divide and control a screen S displayed by the display panel 130 into a plurality of areas. For example, the screen S may be divided into M×N areas (M and N are integers of 2 or more). To this end, the two-dimensional screen S may be divided into N index areas in a scanning direction or in a direction in which the plurality of light sources 111a are arranged, and may be divided into M index areas in a direction parallel to a data line or in a direction perpendicular to the direction in which the plurality of light sources 111a are arranged. The M×N areas may be the basis of motion size calculation, and may not coincide with a pixel unit or a block unit which divides the light sources 111a.

According to an embodiment, the process of dividing the screen S into M×N index areas may include dividing a screen displayed through the display panel into N index areas in the scanning direction, and dividing each of the N index areas into a plurality M sub areas in a direction perpendicular to the scanning direction, where N and M is an integer of 2 or more. Moreover, the process may include calculating a size of a motion for each of the M sub areas of each of the N index areas and synchronizing a dimming signal applied to at least one light source, among the plurality of light sources, with a position of a sub area having a largest size of a motion among the M sub areas in at least one of the N index areas.

The M index areas may have a constant width in the direction parallel to the data line, or may have different widths. Further, the N index areas may have a constant width in the scanning direction, or may have different widths.

According to an embodiment, The number N of areas divided in the scanning direction may be equal to the number of blocks which are control units of the backlight unit 110. According to another embodiment, number N of areas divided in the scanning direction may not be equal to the number of blocks which are control units of the backlight unit 110. According to yet another embodiment, number N of areas divided in the scanning direction may be proportional to the number of blocks which are control units of the backlight unit 110. In this embodiment, the case in which the number N of areas is equal to the number of blocks will be described as an example.

The number M of areas divided in the direction parallel to the data line is the number of areas to be divided by the size of the motion, and the areas have different position values.

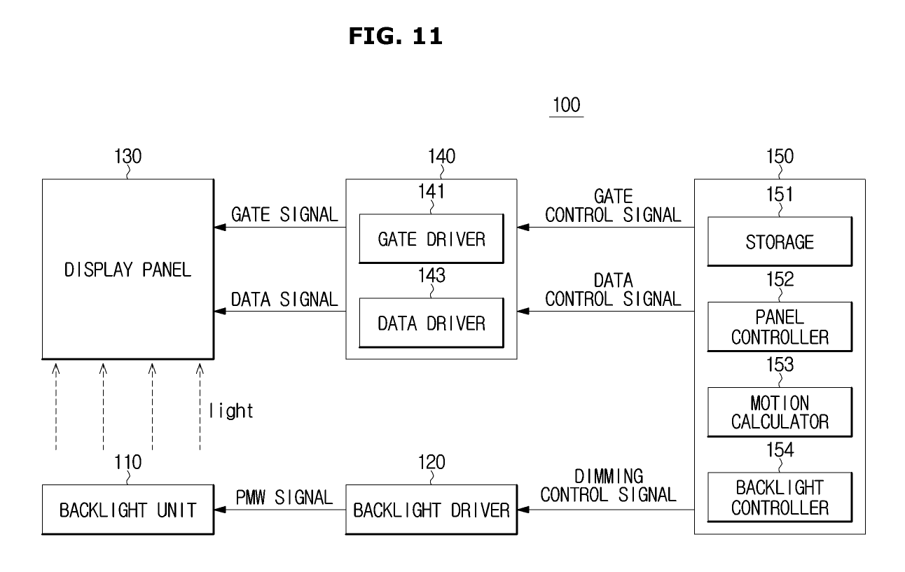

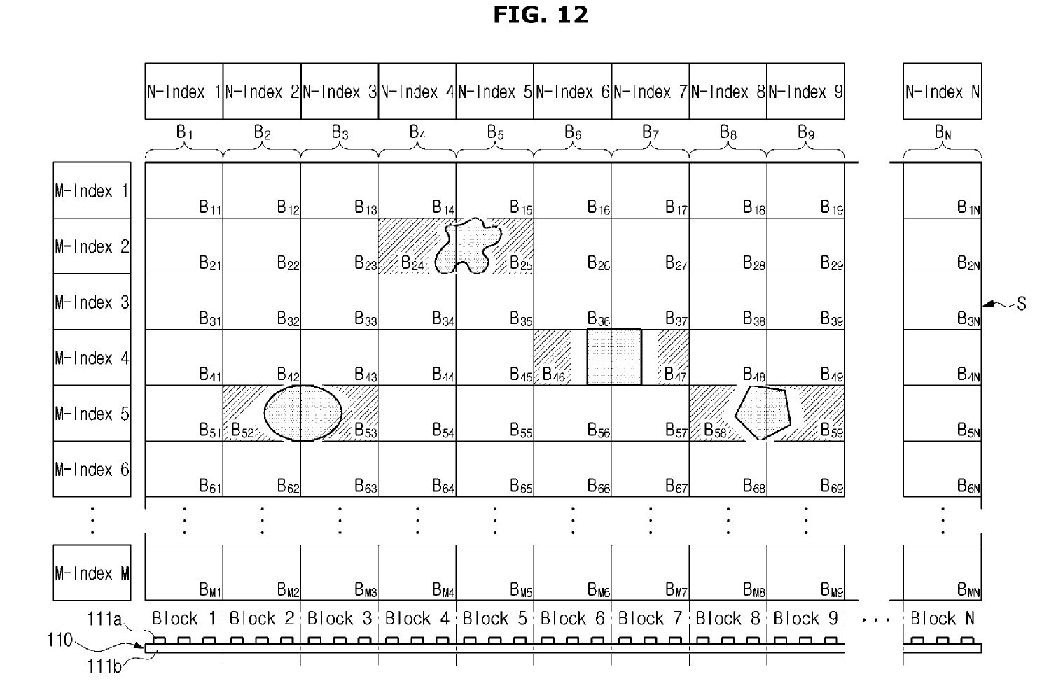

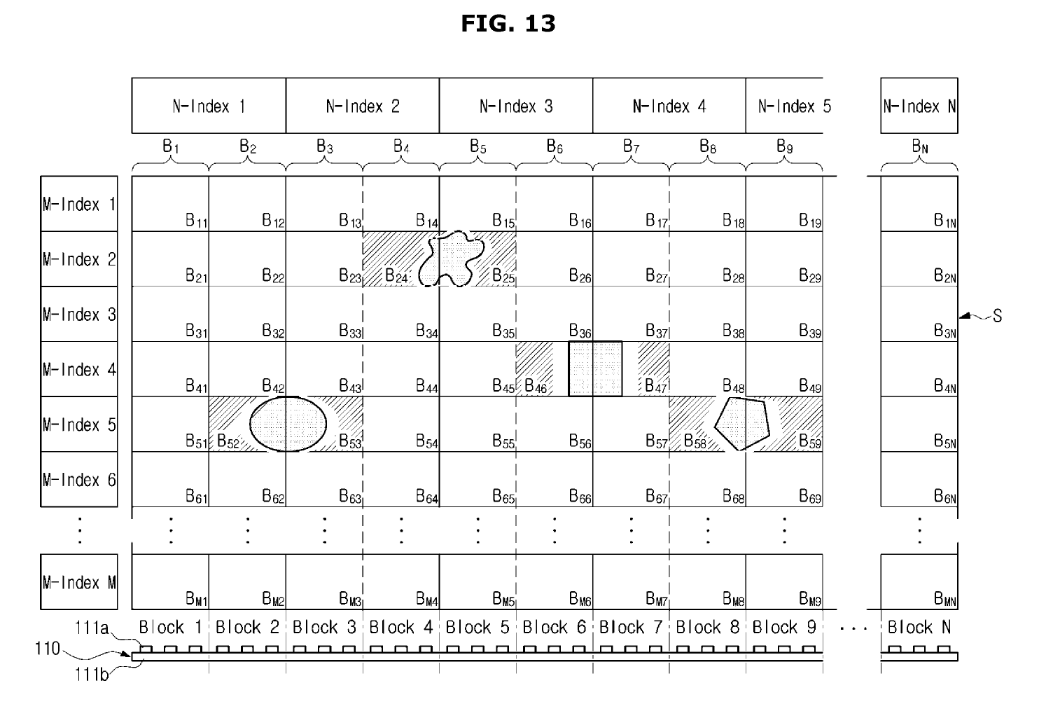

FIG. 11 is a control block diagram showing a configuration of the display apparatus according to the embodiment, and FIGS. 12 and 13 are views showing sizes of motions, which are calculated for each block by the controller of the display apparatus according to the embodiment.

Referring to FIG. 11, a controller 150 may include a storage 151 for storing image data in units of frames, a panel controller 152 for generating a control signal for controlling the display panel 130, a motion calculator 153 for calculating a size of a motion for each area based on a plurality of frame images temporally adjacent to each other, and a backlight controller 154 for generating a dimming control signal for the backlight unit based on the size of the motion for each area.

The controller 150 may include a memory for storing programs and data necessary for performing an operation to be described below, and a processor for executing the stored programs. Further, a plurality of memories and processors may be provided. In this case, the plurality of memories and processors may be integrated on one chip or may be physically separated.

The memory may include a volatile memory such as a static random access memory (SRAM), a dynamic random access memory (DRAM), or the like, or a non-volatile memory such as a read only memory (ROM), an erasable programmable read only memory (EPROM), an electrically erasable programmable read only memory (EEPROM), a flash memory, or the like.

The panel controller 152, the motion calculator 153, and the backlight controller 154 may respectively use separate processors and memories, and may share the processor and the memory.

An image signal input to the controller 150 through an antenna, a set-top box, a playback device, or the like may include information such as a horizontal synchronization signal H_sync, a vertical synchronization signal V_sync, image data, a main clock, a reference clock, and the like.

The panel controller 152 generates a gate control signal and a data control signal based on the input image signal, transmits the generated gate control signal to a gate driver 141, and transmits the generated data control signal to a data driver 143.

The gate driver 141 supplies a scan signal to a plurality of gate lines in response to the transmitted gate control signal, and the data driver 143 supplies a data signal to a plurality of data lines in response to the transmitted data control signal.

The backlight controller 154 modulates the horizontal synchronization signal H_sync and the vertical synchronization signal V_sync based on the reference clock, and generates a dimming control signal based on the horizontal synchronization signal H_sync and the vertical synchronization signal V_sync.

For example, when the vertical synchronization signal V_sync has a frequency of 60 Hz, a dimming control signal may be transmitted to the backlight driver 120 so as to generate a PWM signal having a frequency of 60 Hz, 120 Hz, or 240 Hz.

The backlight driver 120 generates a PWM signal based on the dimming control signal transmitted from the backlight controller 154, and applies the generated PWM signal to the backlight unit 110.

The backlight controller 154 may generate the dimming control signal based on the size of the motion for each area calculated by the motion calculator 153. As described above, according to an embodiment, the light sources 111a of the backlight unit 110 may be controlled in units of blocks, and thus the backlight controller 154 may generate a dimming control signal in units of blocks. In this case, the dimming control signal for each block may be synchronized with a position of an area having a largest motion size among areas constituting a corresponding block.

The motion calculator 153 calculates sizes of motions which appear in two or more frames temporally adjacent to each other among a plurality of frames stored in the storage 151, for each area.

For example, the motion calculator 153 may calculate sizes of motions which appear in a current frame Fₙ and a previous frame Fₙ₋₁. In this case, the motion may be indicated by the movement of a specific object appearing in the frame, and by scene switching. Here, the specific object may include a person, an object, a subtitle, or the like appearing in an image.

The motion calculator 153 may calculate a size of a motion for each of M×N index areas divided in the direction parallel to the data line and in the direction (a scanning direction) parallel to the gate line, as shown in FIG. 12. The areas divided in the arrangement direction of the light sources 111a may be divided into N indexes, and the areas divided in a direction perpendicular to the arrangement direction of the light sources 111a may be divided into M indexes. Further, the M indexes may be indexes for separating rows and the N indexes may be indexes for separating columns based on the scanning direction.

For example, the size of the motion for each area may be calculated using a sum of absolute difference (SAD) algorithm in which an amount of change of pixels appearing in a current frame and a previous frame are calculated for a plurality of pixels constituting each area, absolute values of the amount of change of pixels are summed and then normalized.

Alternatively, the size of the motion may be calculated using a motion vector represented by a moving distance and a moving direction of an object appearing in adjacent frames. An object recognition algorithm using boundary value information, contrast information, color information, and the like may be used for object recognition within a frame. The size of the motion may be calculated by measuring the moving distance and direction in which the object of a current frame moves from a previous frame.

However, the embodiment of the display apparatus 100 is not limited thereto, and there is no limitation on the method of calculating the size of the motion for each area.

The backlight controller 154 may synchronize the dimming point for each block with an area having the largest necessity of motion blur improvement, that is, an area having the largest motion size. Therefore, the backlight controller 154 may compare sizes of motions for a plurality of sub areas constituting each block, and may synchronize a dimming signal for a corresponding block with a position of a sub area having the largest motion size.

Meanwhile, when a subtitle is included in the frame image, an area in which the subtitle is located may be assumed to be an area having the largest motion size. Therefore, when subtitle information is included in input image data, the backlight controller 154 may determine the area in which the subtitle is located as a preferential synchronization position of the dimming signal.

For example, when text is recognized in a specific area in a screen S and has coherent motion vectors, the motion calculator 153 or the backlight controller 154 may determine that the subtitle moving or scrolled in a specific direction is displayed. Specifically, when the text is recognized in the same sub area in a predetermined number or more of blocks and the recognized text has coherent motion vectors, that is, when directions of the motion vectors are the same and the sizes of the motion vectors are the same or similar, the motion calculator 153 or the backlight controller 154 may determine that the subtitle scrolled in left and right directions or in the direction in which the light sources 111a are arranged is displayed.

Further, the dimming signal may be synchronized preferentially with a stopped subtitle as well as the scrolled subtitle. For example, when a translation subtitle in which dialogue is translated is displayed, the motion calculator 153 or the backlight controller 154 may determine that a motion has occurred at a time point at which the translation subtitle is switched and may synchronize the dimming signal with the area in which the translation subtitle is displayed. As described above, it is possible to determine the switching of the subtitle using the motion vectors. When subtitle information and frame information in which each subtitle is displayed are included in an image signal, it is also possible to determine the switching time of the subtitle using the corresponding information.

In some embodiments, when an area in which a subtitle is displayed is present in the block, the dimming signal may be synchronized preferentially with the area in which the subtitle is displayed without comparing the sizes of the motions. Even when an area in which a subtitle is displayed is present therein, a synchronization position of the dimming signal may be determined according to the size of the motion.

The backlight controller 154 compares sizes of motions of M sub areas B₁₁, B₂₁, B₃₁, . . . , B_{M1} included in a first block area B₁ (as shown in FIGS. 12 and 13), which is a dominant area of a first block Block 1, and synchronizes a dimming signal for the first block Block 1 with a position of a sub area having a largest motion size. Here, the dominant area of the first block refers to an area to which light is supplied from a light source 111a of the first block.

Further, the backlight controller 154 compares sizes of motions of M sub areas B₁₂, B₂₂, B₃₂, . . . , B_{M2} included in a second block area B₂, which is a dominant area of a second block Block 2, and synchronizes a dimming signal for the second block Block 2 with a position of a sub area having a largest motion size. In the same manner, a dimming signal for an N^{th} block Block N may be synchronized with a position of a sub area having a largest motion size.

Synchronizing a dimming signal with a specific position may refer to synchronizing an application time point of a PWM signal with a time point at which an image at a corresponding position is scanned, that is, a pixel at a corresponding position is scanned. In this case, the application time point of the PWM signal and the scanning time point at the corresponding position may have a specific offset. For example, the PWM signal may be applied to a light source of a block corresponding to a relevant position immediately before or at a predetermined time before the image is scanned in the pixel at the specific position.

An image in a transient period may be minimally shown by providing an offset between the scanning time point at which the size of the motion is large and the application time point of the PWM signal, and thus a motion blur phenomenon may be improved.

Meanwhile, when the size of the motion is not greater than a reference value, it is determined that the necessity of motion blur improvement is not large, and the time point of the dimming signal may not be synchronized with a specific area. Therefore, when a largest value of sizes of motions for sub areas constituting each block area is greater than or equal to a preset reference value, the backlight controller 154 may perform the above-described dimming point control, and when the largest value of the sizes of the motions is less than the preset reference value, the dimming point may be synchronized with a default position. For example, a position having the same index for each block may be set as the default position.

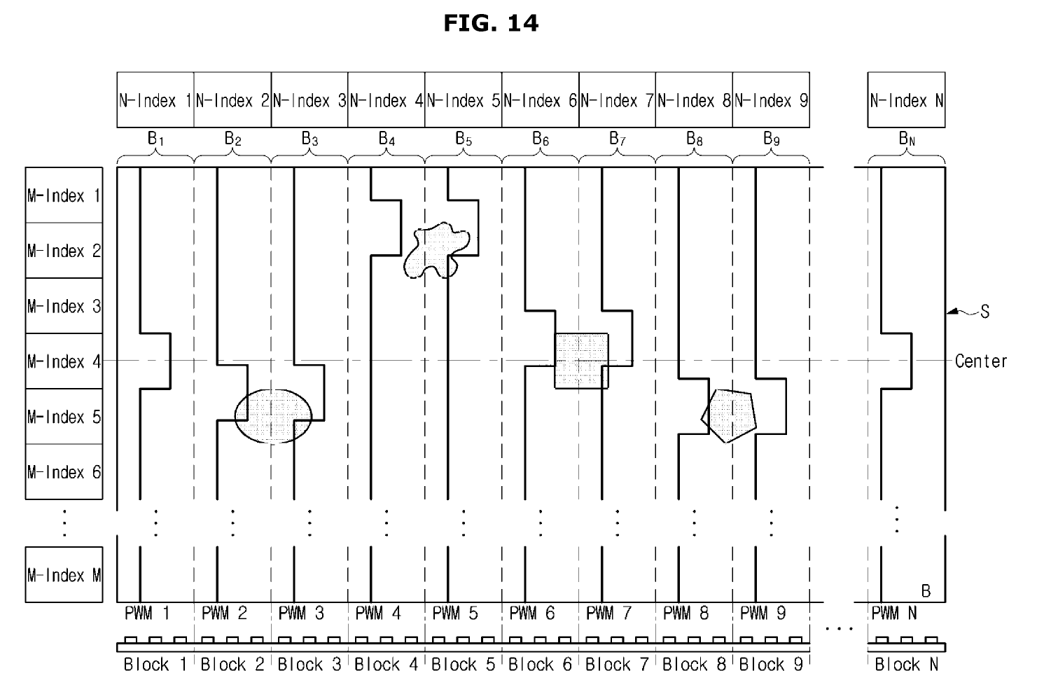

Specifically, a position corresponding to the center of the entire screen S (as shown in FIG. 14), that is, a position of a sub area corresponding to the center of the plurality of sub areas constituting each block area may be set as the default position. Specifically, when a single block area is composed of seven sub areas, a position of a sub area having Index 4 may be a default position of the dimming point.

Alternatively, a position outside the center of the entire screen S may be set as the default position, and an upper or lower end of the entire screen S may be set as the default position. In the embodiment of the display apparatus 100, the default position of the dimming point is not limited.

In FIG. 12, the case in which the areas divided to calculate the size of the motion and the sub areas included in each block area coincide with each other is shown according to an embodiment. However, even when the area used as a reference for calculating a motion size is larger than the block unit dividing the light sources 111a, an operation of controlling the dimming point may be applied in the same manner.

For example, as shown according to an other embodiment in FIG. 13, even when a single area used as a reference for calculating a motion size is located over two block areas, that is, even when two adjacent block areas share a single area used as a reference for calculating a motion size, it is the same that the dimming point is synchronized with a position of a sub area having the largest motion size among sub areas constituting a single block area, except that two adjacent blocks have the same dimming point.

According to the example of FIG. 12, in the second block area B₂ and a third block area B₃, sub areas B₅₂ and B₅₃ having an M-Index 5 have the largest motion size, and in a fourth block area B₄ and a fifth block area B₅, sub areas B₂₄ and B₂₅ having an M-Index 2 have the largest motion size. Further, in a sixth block area B₆ and a seventh block area B₇, sub areas B₄₆ and B₄₇ having an M-Index 4 have the largest motion size, and in an eighth block area B₈ and a ninth block area B₉, sub areas B₅₈ and B₅₉ having an M-Index 5 have the largest motion size.

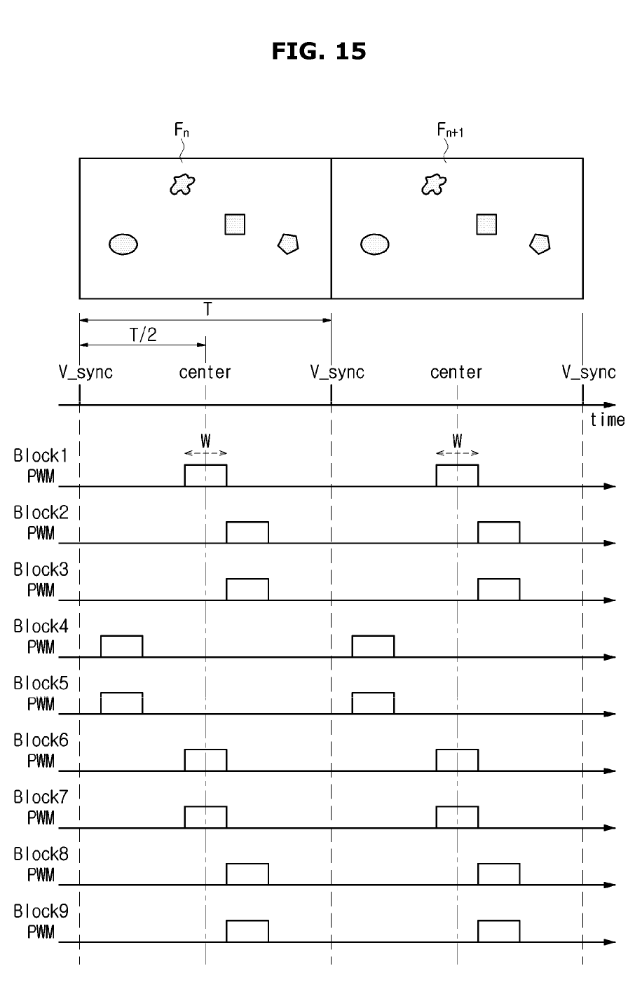

In the case in which the size of the motion for each area is the same as the example of FIG. 12, to the manner of performing the dimming control of the backlight unit 110 according to an embodiment will be described below with reference to FIGS. 14 and 15.

FIG. 14 is a diagram showing a position-based PWM signal applied for each block of a backlight unit in the case in which the size of the motion for each area is the same as the example of FIG. 12, and FIG. 15 is a diagram showing a time-based PWM signal supplied for each block of the backlight unit in the case in which the size of the motion for each area is the same as the example of FIG. 12.

Referring to FIGS. 12 and 14, since the motion in the first block area B₁ does not exceed the reference value, a PWM signal supplied to a light source 111a of the first block Block 1 is synchronized with the default position. In this embodiment, it is assumed that the default position is a center position.

Since the second block area B₂ has the largest size of the motion in the sub area B₅₂ having the M-Index 5, a PWM signal supplied to a light source 111a of the second block Block 2 is synchronized with a position of the sub area B₅₂ having the M-Index 5.

Since the third block area B₃ has the largest size of the motion in the sub area B₅₃ having the M-Index 5, a PWM signal supplied to a light source 111a of the third block Block 3 is synchronized with a position of the sub area B₅₃ having the M-Index 5.

Since the fourth block area B₄ has the largest size of the motion in the sub area B₂₄ having the M-Index 2, a PWM signal supplied to a light source 111a of the fourth block Block 4 is synchronized with a position of the sub area B₂₄ having the M-Index 2.

Since the fifth block area B₅ has the largest size of the motion in the sub area B₂₅ having the M-Index 2, a PWM signal supplied to a light source 111a of the fifth block Block 5 is synchronized with a position of the sub area B₂₅ having the M-Index 2.

Since the sixth block area B₆ has the largest size of the motion in the sub area B₄₆ having the M-Index 4, a PWM signal supplied to a light source 111a of the sixth block Block 6 is synchronized with a position of the sub area B₄₆ having the M-Index 4.

Since the seventh block area B₇ has the largest size of the motion in the sub area B₄₇ having the M-Index 4, a PWM signal supplied to a light source 111a of the seventh block Block 7 is synchronized with a position of the sub area B₄₇ having the Index M-4.

Since the eighth block area B₈ has the largest size of the motion in the sub area B₅₈ having the Index M-5, a PWM signal supplied to a light source 111a of the eighth block Block 8 is synchronized with a position of the sub area B₅₈ having the Index M-5.

Since the ninth block area B₉ has the largest size of the motion in the sub area B₅₉ having the Index M-5, a PWM signal supplied to a light source 111a of the ninth block Block 9 is synchronized with a position of the sub area B₅₉ having the Index M-5.

In the same manner, a PWM signal may be applied to a light source 111a of the N^{th} block Block N.

As described above, synchronizing the PWM signal with a specific position in the screen S refers to synchronizing a time point at which an image is displayed at a corresponding position with an application time point of the PWM signal. The time point at which the image is displayed at a specific position may be determined based on the scanning direction and a scanning speed, and the PWM signal may be supplied based on the determined time point. In this embodiment, since the progressive scanning method is employed, scanning is sequentially performed from the first gate line to the last gate line.

Referring to FIG. 15, since the PWM signal supplied to the light source 111a of the first block Block 1 is synchronized with a center position, the PWM signal is applied to the light source 111a of the first block Block 1 at a time point at which an image is displayed at a center position of an n^{th} frame Fₙ. Specifically, the PWM signal may be applied at an intermediate time point T/2 within one period T of the vertical synchronization signal V_sync. Here, an offset may not be provided.

Since the PWM signal supplied to the light source 111a of the second block Block 2 is synchronized with the position of the sub area B₅₂ having the M-Index 5, the PWM signal is applied to the light source 111a of the second block Block 2 at a time point which is synchronized with the time point at which the image is displayed at the position of the sub area B₅₂ having the M-Index 5 in the n^{th} frame Fₙ. An application time point of the PWM signal may have an offset with the time point at which the image is displayed at the position of the sub area B₅₂ having the M-Index 5.

Since the PWM signal supplied to the light source 111a of the third block Block 3 is synchronized with the position of the sub area B₅₃ having the M-Index 5, the PWM signal is applied to the light source 111a of the third block Block 3 at a time point which is synchronized with the time point at which the image is displayed at the position of the sub area B₅₃ having the M-Index 5 in the n^{th} frame Fₙ. An application time point of the PWM signal may have an offset with the time point at which the image is displayed at the position of the sub area B₅₃ having the M-Index 5.

Since the PWM signal supplied to the light source 111a of the fourth block Block 4 is synchronized with the position of the sub area B₂₄ having the M-Index 2, the PWM signal is applied to the light source 111a of the fourth block Block 4 at a time point which is synchronized with the time point at which the image is displayed at the position of the sub area B₂₄ having the M-Index 2 in the n^{th} frame Fₙ. An application time point of the PWM signal may have an offset with the time point at which the image is displayed at the position of the sub area B₂₄ having the M-Index 2.

Since the PWM signal supplied to the light source 111a of the fifth block Block 5 is synchronized with the position of the sub area B₂₅ having the Index 2, the PWM signal is applied to the light source 111a of the fifth block Block 5 at a time point which is synchronized with the time point at which the image is displayed at the position of the sub area B₂₅ having the M-Index 2 in the n^{th} frame Fₙ. An application time point of the PWM signal may have an offset with the time point at which the image is displayed at the position of the sub area B₂₅ having the M-Index 2.

Since the PWM signal supplied to the light source 111a of the sixth block Block 6 is synchronized with the position of the sub area B₄₆ having the M-Index 4, the PWM signal is applied to the light source 111a of the sixth block Block 6 at a time point which is synchronized with the time point at which the image is displayed at the position of the sub area B₄₆ having the M-Index 4 in the n^{th} frame Fₙ. An application time point of the PWM signal may have an offset with the time point at which the image is displayed at the position of the sub area B₄₆ having the M-Index 4.

Since the PWM signal supplied to the light source 111a of the seventh block Block 7 is synchronized with the position of the sub area B₄₇ having the M-Index 4, the PWM signal is applied to the light source 111a of the seventh block Block 7 at a time point which is synchronized with the time point at which the image is displayed at the position of the sub area B₄₇ having the M-Index 4 in the n^{th} frame Fₙ. An application time point of the PWM signal may have an offset with the time point at which the image is displayed at the position of the sub area B₄₇ having the M-Index 4.

Since the PWM signal supplied to the light source 111a of the eighth block Block 8 is synchronized with the position of the sub area B₅₈ having the M-Index 5, the PWM signal is applied to the light source 111a of the eighth block Block 8 at a time point which is synchronized with the time point at which the image is displayed at the position of the sub area B₅₈ having the M-Index 5 in the n^{th} frame Fₙ. An application time point of the PWM signal may have an offset with the time point at which the image is displayed at the position of the sub area B₅₈ having the M-Index 5.

Since the PWM signal supplied to the light source 111a of the ninth block Block 9 is synchronized with the position of the sub area B₅₉ having the M-Index 5, the PWM signal is applied to the light source 111a of the ninth block Block 9 at a time point which is synchronized with the time point at which the image is displayed at the position of the sub area B₅₉ having the M-Index 5 in the n^{th} frame Fₙ. An application time point of the PWM signal may have an offset with the time point at which the image is displayed at the position of the sub area B₅₉ having the Index 5.

Meanwhile, a pulse width of the PWM signal may vary according to a brightness value of the corresponding block. However, in the example of FIG. 15, a pulse width of the PWM signal is shown constantly for each block for convenience of description.

A motion blur phenomenon occurring after the n^{th} frame Fₙ may be improved in the same manner. In FIG. 15, the case in which a comparison result of a motion size for an (n+1)^{th} frame Fₙ₊₁ is the same as a comparison result of a motion size for the n^{th} frame Fₙ is assumed and shown.

As described above, when the dimming control for the edge type backlight unit 110 is performed, the screen may be divided into the plurality of areas in the direction perpendicular to the arrangement direction of the light sources (or the direction parallel to the data line) and the dimming point may be synchronized with the position of the area having the largest motion size among the plurality of areas, and thus a local dimming effect may be obtained and the motion blur phenomenon may be effectively improved.

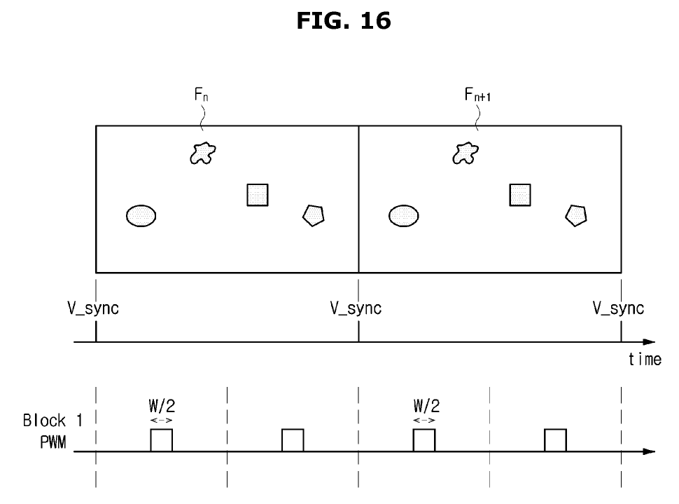

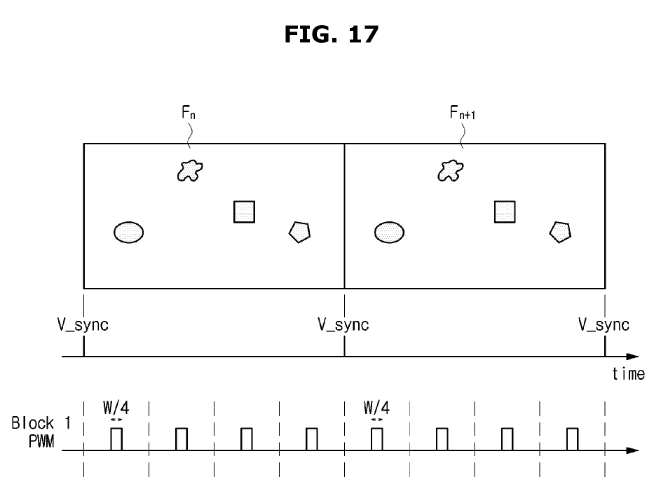

Meanwhile, the backlight controller 154 may perform dimming control to improve a flicker phenomenon for a block in which no motion having a size greater than or equal to a reference value is present. Hereinafter, the dimming control to improve the flicker phenomenon will be described with reference to FIGS. 16 and 17.

FIGS. 16 and 17 are diagrams showing examples of a PWM signal applied to improve a flicker phenomenon.

When a frequency of a PWM signal applied to the backlight unit coincides with a frame rate, a screen flicker phenomenon, that is, a flicker phenomenon, may be visually recognized. For example, when a frame rate is 60 Hz and a frequency of a PWM signal applied to the backlight unit is also 60 Hz, a flicker phenomenon may be visually recognized.

Therefore, the backlight controller 154 may apply a PWM signal at a frequency higher than the frame rate to a block in which a motion having a reference size or more is not displayed. For example, the PWM signal may be applied at an integral multiple of the frame rate.

Referring to the example of FIG. 16, a PWM signal may be applied at a frequency twice the frame rate. In this case, a pulse width of a single PWM signal may be adjusted to correspond to ½ of the brightness of the corresponding block area, so that the total brightness may be constantly maintained.

Further, as shown in an example of FIG. 17, a PWM signal may be applied at a frequency four times the frame rate. In this case, a pulse width of a single PWM signal may be adjusted to correspond to ¼ of the brightness of the corresponding block area.

In this case, the display apparatus 100 may simultaneously obtain an effect of improving the motion blur and an effect of removing the flicker.

Hereinafter, an embodiment of a control method of a display apparatus will be described. The display apparatus 100 according to the above-described embodiment may be used for a control method of a display apparatus according to an embodiment. Therefore, the descriptions of FIGS. 1 to 17 described above are equally applicable to the control method of the display apparatus described below even when not specifically mentioned.

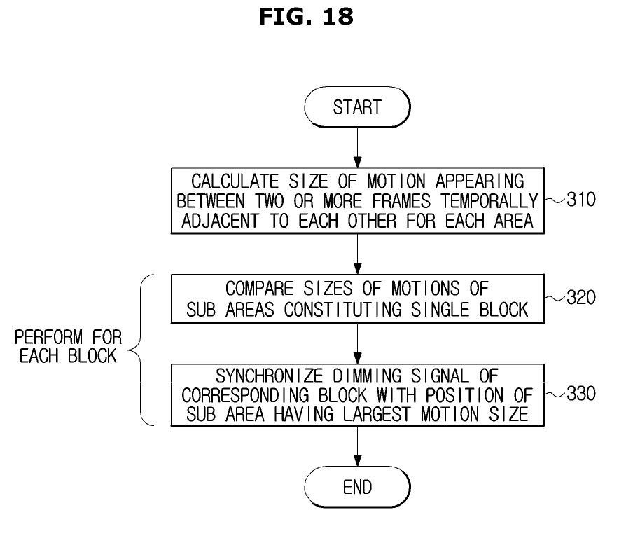

FIG. 18 is a flowchart of a control method of a display apparatus according to an embodiment.

Referring to FIG. 18, sizes of motions appearing between two or more frames temporally adjacent to each other are calculated for each area (310). For example, the controller 150 may calculate the sizes of the motions using a current frame and a previous frame among image data stored in units of frames. An area used as a reference for calculating a motion size may be M×N index areas (M and N are integers of 2 or more) obtained by dividing the screen S displayed by the display panel 130 as shown in FIGS. 9 and 10.

The motion may be indicated by the movement of a specific object appearing in a frame, or by scene switching. Here, the specific object may include a person, an object, a subtitle, or the like. The sizes of the motions may be calculated based on a pixel change which occurs in a current frame and a previous frame for a plurality of pixels constituting each area, and may be calculated using motion vectors of an object appearing in the current frame and the previous frame.

Meanwhile, the plurality of light sources 111a constituting the backlight unit 110 may be controlled in units of blocks. One block may include at least one light source. The controller 150 may synchronize a dimming point for each block with an area having the largest necessity of motion blur improvement, that is, an area having the largest motion size.

To this end, the controller 150 compares sizes of motions of sub areas constituting a single block area (320). The sub area may be a single block area, among N block areas, divided into M index areas, and positions of sub areas constituting a single block are as shown in FIGS. 12 and 13. For example, sizes of motions for sub areas constituting a first block area are compared in order to generate a dimming signal applied to the light source 111a of the first block. The size of the motion for each sub area may be calculated using the size of the motion calculated for each area in the previous stage.

A dimming signal of a corresponding block is synchronized with a position of a sub area having the largest motion size (330). For example, a dimming signal of the first block may be synchronized with the position of the sub area having the largest motion size among the sub areas constituting the first block area. Synchronizing the dimming signal with a specific position refers to synchronizing an application time point of a PWM signal with a time point at which the corresponding position is scanned. In this case, the application time point of the PWM signal and the scanning time point have a specific offset so that an image in a transient period may be minimized. For example, the PWM signal may be applied to the light source of the block corresponding to a relevant position immediately before the image is scanned in the pixel at a specific position.

According to an embodiment, the comparing of the sizes of the motions (320) and the synchronizing of the dimming signal with the position having the largest motion size (330) may be performed for each of blocks constituting the backlight unit 110, and the calculating of the size of the motion (310), the comparing of the sizes of the motions (320), and the synchronizing of the dimming signal (330) may be performed for each frame.

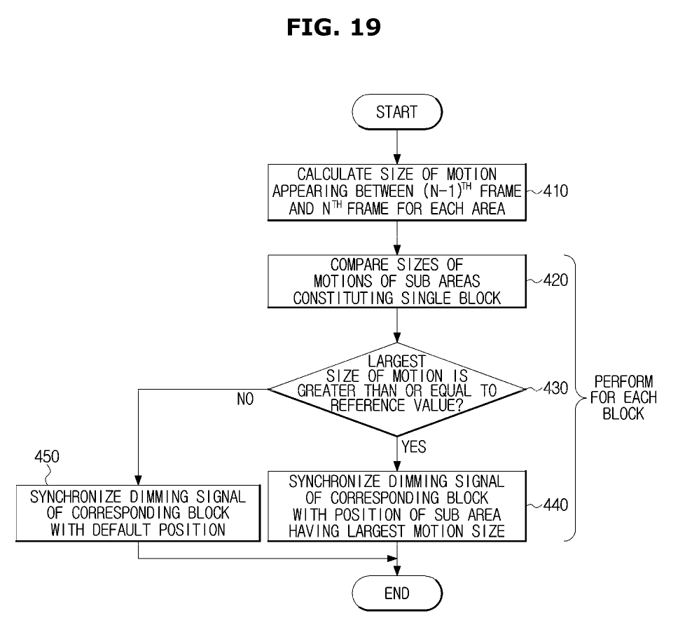

FIG. 19 is another flowchart of a control method of a display apparatus according to an embodiment. An example of FIG. 19 relates to the case in which a current frame is an n^{th} frame Fₙ.

Referring to FIG. 19, a size of a motion appearing between an (n-1)^{m} frame Fₙ₋₁ and the n^{th} frame Fₙ is calculated for each area (410). The calculation of the size of the motion for each area is the same as that described in FIG. 18. Sizes of motions of sub areas constituting a single block are compared (420).

Meanwhile, when the size of the motion is not greater than or equal to a reference value, it is determined that the necessity of motion blur improvement is not large, and the time point of the dimming signal may not be synchronized with a specific area. Therefore, when a largest motion size is less than the reference value (NO in 430), a dimming signal of a corresponding block may be synchronized with a default position (450). For example, a position having the same index for each block may be set as the default position. Specifically, a position corresponding to the center of the entire screen S, that is, a position of a sub area corresponding to the center of the plurality of sub areas constituting each block area may be set as the default position. Alternatively, a position outside the center of the entire screen S may be set as the default position, and an upper or lower end of the entire screen S may be set as the default position. In the embodiment of the control method of the display apparatus, the default position of the dimming point is not limited.

When the largest motion size is greater than or equal to the reference value (YES in 430), the dimming control is performed according to the motion size as described above. Specifically, the dimming signal of the corresponding block is synchronized with a position of the sub area having largest motion size (440). The synchronization of the dimming signal is the same as that described above.

In the same manner, the comparing of the motion size (420 and 430) and the synchronization of the dimming signal (440 and 450) may be performed for each of the blocks constituting the backlight unit 110, and the calculating of the size of the motion (410), the comparing of the sizes of the motions (420 and 430), and the synchronizing of the dimming signal (440 and 450) may be performed for each frame.

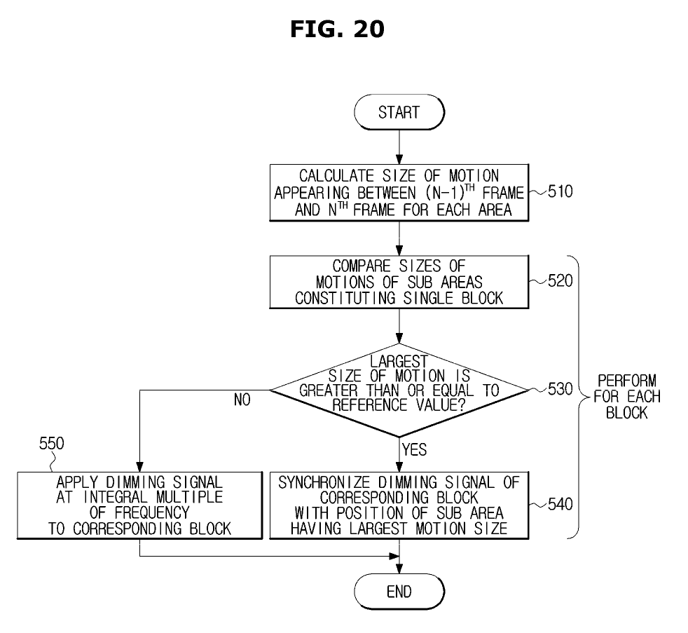

FIG. 20 is still another flowchart of a control method of a display apparatus according to an embodiment. An example of FIG. 20 relates to the case in which a current frame is an n^{th} frame Fₙ.

Referring to FIG. 20, a size of a motion appearing between an (n-1)^{m} frame Fₙ₋₁ and the n^{th} frame Fₙ is calculated for each area (510). The calculation of the size of the motion for each area is the same as that described in FIG. 18.

Sizes of motions of sub areas constituting a single block are compared (520).

Meanwhile, when the size of the motion is not greater than a reference value, it is determined that the necessity of motion blur improvement is not large, and the time point of the dimming signal may not be synchronized with a specific area. Instead, the dimming control may be performed to improve a flicker phenomenon.

Therefore, when a largest motion size is less than the reference value (NO in 530), a dimming signal may be applied to a corresponding block at an integral multiple of a frame rate (550). For example, as shown in the example of FIG. 16, a PWM signal may be applied at a frequency twice the frame rate. In this case, a pulse width (W/2) of a single PWM signal may be adjusted to correspond to ½ of the brightness of the corresponding block area, so that the total brightness may be constantly maintained. Further, as shown in the example of FIG. 17, a PWM signal may be applied at a frequency four times the frame rate. In this case, a pulse width (W/4) of a single PWM signal may be adjusted to correspond to ¼ of the brightness of the corresponding block area.

When the largest motion size is greater than or equal to the reference value (YES in 530), the dimming control is performed according to the motion size as described above. Specifically, the dimming signal of the corresponding block is synchronized with a position of the sub area having largest motion size (540). The synchronization of the dimming signal is the same as that described above.

In the same manner, the comparing of the motion size (520 and 530) and the application of the dimming signal (540 and 550) may be performed for each of the blocks constituting the backlight unit 110, and the calculating of the size of the motion (510), the comparing of the sizes of the motions (520 and 530), and the application of the dimming signal (540 and 550) may be performed for each frame.

Meanwhile, when a subtitle is included in a frame image, an area in which the subtitle is located may be assumed as an area having the largest motion size. Therefore, when subtitle information is included in the input image data, the controller 150 may determine the area in which the subtitle is located as a preferential synchronization position of the dimming signal. The embodiment in which the dimming signal is preferentially synchronized with the area in which the subtitle is located is the same as that described above in the embodiment of the display apparatus 100.

According to the above-described embodiments of the display apparatus and the control method thereof, when the light sources of the backlight unit are arranged on at least one side of the display panel in the scanning direction, an optimal motion blur improvement effect may be obtained by synchronizing a dimming point of a light source with an area having the largest necessity of motion blur improvement that is, an area having a largest motion size.

Specifically, when the dimming control for the edge type backlight unit is performed, the screen is divided into the plurality of areas in the direction perpendicular to the arrangement direction of the light sources (or the direction parallel to the data line) and the dimming point is synchronized with the position of the area having the largest motion size among the plurality of areas, and thus a local dimming effect may be obtained and the motion blur phenomenon may be effectively improved.

Further, an effect of improving the motion blur and an effect of removing the flicker may be simultaneously obtained by performing the dimming control to improve the flicker phenomenon in the area in which the size of the motion is not large.

As is apparent from the above description, according to an aspect of the present disclosure, in a display apparatus and a control method thereof, when an edge type display panel in which light sources of a backlight unit are arranged on at least one side of the display panel in a scanning direction is employed, an optimal motion blur improvement effect can be obtained by synchronizing a dimming point of the light source with an area having the largest necessity of motion blur improvement, that is, an area having the largest motion size.

Although a few embodiments of the present disclosure have been shown and described, it should be appreciated by those skilled in the art that changes may be made in these embodiments without departing from the principles and spirit of the disclosure, the scope of which is defined in the claims and their equivalents.

What is claimed is:

1. A display apparatus comprising:
a display panel configured to display a plurality of frame images;
a backlight unit comprising a plurality of light sources provided on at least one side of the display panel, the plurality of lights being arranged in a scanning direction of the display panel; and
a controller configured to divide an area of the display panel into a plurality of sub areas in a first direction perpendicular to a second direction in which the plurality of light sources are arranged and synchronize a dimming signal applied to at least one light source, among the plurality of light sources, at a position of a sub area having a largest size of a motion among the plurality of sub areas.

2. The display apparatus according to claim 1, wherein the controller is further configured to generate a dimming control signal for synchronizing an application time point of the dimming signal with a scanning time point of the sub area having the largest size of the motion.

3. The display apparatus according to claim 2, wherein the controller is further configured to the dimming control signal by providing an offset between the scanning time point of the sub area having the largest size of the motion and the application time point of the dimming signal.

4. The display apparatus according to claim 1, wherein the controller is further configured to compare the largest size of the motion to a preset reference value, and synchronize the dimming signal with the position of the sub area having the largest size of the motion when the largest size of the motion is greater than or equal to the reference value.

5. The display apparatus according to claim 1, wherein the controller is further configured to calculate the size of the motion for each of the sub areas using two or more frame images temporally adjacent to each other among the plurality of frame images.

6. The display apparatus according to claim 1, wherein the controller is further configured to calculate the size of the motion using a current frame image and a previous frame image among the plurality of frame images.

7. The display apparatus according to claim 1, wherein the controller is further configured to divide a screen displayed through the display panel into M areas in a direction perpendicular to the scanning direction and divide the screen into N areas in the scanning direction, and calculate the size of the motion for each of M×N areas, wherein M and N are integers of 2 or more.

8. The display apparatus according to claim 7, wherein the controller is further configured to divide the plurality of light sources into a plurality of blocks and controls the plurality of blocks in units of blocks.

9. The display apparatus according to claim 8, wherein a number of the blocks is proportional to a number of the N areas divided in the scanning direction in order to calculate the size of the motion.

10. The display apparatus according to claim 8, wherein the controller is further configured to determine a position of a sub area having a largest size of a motion for each block, and synchronize a dimming signal applied to a light source included in the block with the position of the sub area having the largest size of the motion.

11. The display apparatus according to claim 1, wherein, when a sub area including a subtitle is present among the plurality of sub areas, the controller is further configured to synchronize the dimming signal with the sub area including the subtitle.

12. The display apparatus according to claim 4, wherein, when the largest size of the motion is less than the reference value, the controller is further configured to generate a dimming control signal for applying the dimming signal at an integer multiple of a frame frequency to the plurality of frame images.

13. The display apparatus according to claim 1, wherein the dimming signal comprises a pulse width modulation (PWM) signal.

14. The display apparatus according to claim 1, wherein the backlight unit comprises a plurality of light sources arranged to face each other at both sides of the display panel.

15. A control method of a display apparatus comprising a display panel configured to display a plurality of frame images, and a backlight unit comprising a plurality of light sources disposed on at least one side of the display panel and arranged in a scanning direction of the display panel, the method comprising:
dividing a screen displayed through the display panel into N areas in the scanning direction;
dividing each of the N areas into a plurality M sub areas in a direction perpendicular to the scanning direction;
calculating a size of a motion for each of the M sub areas of each of the N areas; and
synchronizing a dimming signal applied to at least one light source, among the plurality of light sources, with a position of a sub area having a largest size of a motion among the M sub areas in at least one of the N areas,
wherein M and N are integers of 2 or more.

16. The control method according to claim 15, wherein the synchronizing of the dimming signal comprises synchronizing an application time point of the dimming signal with a scanning time point of the sub area having the largest size of the motion.

17. The control method according to claim 16, wherein the synchronizing of the dimming signal comprises providing an offset between the scanning time point of the sub area having the largest size of the motion and the application time point of the dimming signal.

18. The control method according to claim 15, wherein the synchronizing of the dimming signal comprises:
comparing the largest size of the motion to a preset reference value; and
synchronizing the dimming signal with the position of the sub area having the largest size of the motion when the largest size of the motion is greater than or equal to the reference value.

19. The control method according to claim 15, wherein the calculating of the size of the motion comprises calculating the size of the motion using two or more frame images temporally adjacent to each other among the plurality of frame images.

20. The control method according to claim 15, wherein the calculating of the size of the motion comprises calculating the size of the motion using a current frame image and a previous frame image among the plurality of frame images.

21. A controller comprising:
a processor configured to:
divide a screen displayed through a display panel into N areas in a first direction of the display panel;
divide each of the N areas into a plurality M sub areas in a second direction perpendicular to the first direction;
calculate a size of a motion for each of the M sub areas of each of the N areas; and
synchronize a dimming signal applied to at least one light source,
among a plurality of light sources, based on the calculated size of the motion for each of the M sub areas in at least one of the N areas.

22. The controller according to claim 21, wherein the processor is further configured to synchronize the dimming signal applied to the at least one light source, among a plurality of light sources, based on a position of a sub area having a largest size of a motion among the M sub areas in the at least one of the N areas.

23. The controller according to claim 22, wherein the processor is further configured to:
compare the largest size of the motion to a preset reference value; and
synchronize the dimming signal with the position of the sub area having the largest size of the motion when the largest size of the motion is greater than or equal to the reference value.
